(19) United States
(12) Patent Application Publication
(10) Pub. No.: US 2001/0056366 A1
(43) Pub. Date: Dec. 27, 2001

(54) Targeted response generation system

(76) Inventor: Robert W. Naismith, Lake Winola, PA (US)

Correspondence Address: McAndrews, Held & Malloy, Ltd., 500 W. Madison Street, 34th Floor, Chicago, IL, 60661, US

(21) Appl. No.: 09/867,882

(22) Filed: May 30, 2001

Related U.S. Application Data
(60) Provisional application No. 60/207,822, filed on May 30, 2000.

(51) Int. Cl. G06F 17/60

(52) U.S. Cl. 705/10; 705/35; 709/207

(57) ABSTRACT

A system for generating a targeted response for investment banking services based on user interest. First, a client corporation and a specific investment banking objective for the client corporation are identified. A web site detailing the corporation and its investment banking objective are then constructed. An e-mail database of potential interested parties, including companies in a similar area to the client corporation, is constructed. The address of the web site is sent to the potential interested parties who then login to the web site. The web site includes a login procedure recording a user profile for each user and issuing the user a password. The user then accesses the web site. The usage statistics of the user for the web site are recorded and analyzed. A targeted response to the user is selected from a variety of responses based on the interests of the user as determined from an interpretation of the usage statistics.

### BACKGROUND OF THE INVENTION

The present invention generally relates to a targeted response generation system. More particularly, the present invention relates to a targeted response generation system determining a targeted response from a variety of responses based on the interests of the user as determined from an interpretation of the usage statistics of a website.

### SUMMARY OF THE INVENTION

The present invention provides a targeted response generation system determining a targeted response based on the interests of the user as determined from an interpretation of the usage statistics of a web site. A client corporation web site is established and access to the web site is provided to a number of pre-identified potential interested users via e-mail or other sources of communication. When the users first access the web site, they complete a user profile and are issued a password. The activity of the users on the web site is recorded and analyzed to determine a targeted response from among a variety of potential responses based on the interest of the user. The user's interest is determined from the analysis of the user's web usage statistics.

These and other features of the present invention are discussed or apparent in the following detailed description of the preferred embodiments of the invention.

### BRIEF DESCRIPTION OF THE DRAWINGS

FIG. 1 illustrates a targeted response generation system according to a preferred embodiment of the present invention.

FIG. 2 illustrates a flowchart of a preferred embodiment of the present invention.

### DETAILED DESCRIPTION OF THE PREFERRED EMBODIMENTS

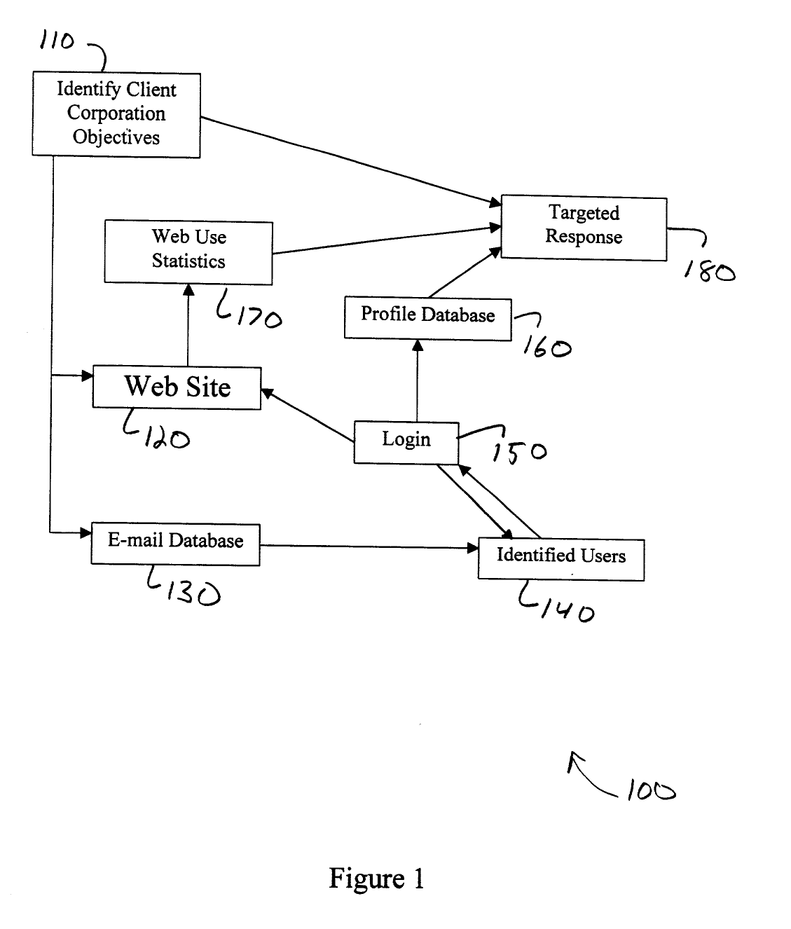

FIG. 1 illustrates a targeted response generation system 100 according to a preferred embodiment of the present invention. The targeted response generation system 100 includes a client corporation objective identifier 110, a web site 120, an e-mail database 130, identified users 140, a login 150, a profile database 160, a web use statistics database 170, and a targeted response generator 180.

In operation, a client corporation 110 requests services or a transaction. Preferably, these services include specific investment banking services such as Initial Public Offering (IPO) assistance, merger assistance, recapitalization assistance and the like. Information regarding the client corporation and the specific service requested is compiled and placed in an internet-accessible location. Preferably, the information is placed on the web site 120 which may be easily accessed through the World Wide Web (WWW) via any of a number of conventional web browsers such as Netscape Navigator® or Internet Explorer®.

Information included on the web site may include the companies goals, history, management details, capital and debt structure, science, therapeutic potential of technology, intellectual property, royalty agreements, research collaboration or other information. An example of a web site for a specific corporation is included as Appendix A.

Once the web site 120 has been constructed, and e-mail database 130 is assembled. The e-mail database 130 includes e-mail addressed for individuals and corporations that have been identified by a preliminary search as potentially interested in the client corporation or its present transaction. For example, companies similar to the client company 110 may be identified, as well as the Presidents, research executives of Vice-Presidents for business development of similar companies. The e-mail addresses for the identified companies and individuals are assembled into the e-mail database.

Once the e-mail database 130 has been constructed, an introductory e-mail is sent to the e-mail addresses included in the e-mail database 130. The introductory e-mail may include the HTML (Hyper-Text Markup Language) address of the web site 120 and a brief summary of the client company and the potential transaction. The introductory e-mail is received by the identified users 140. The identified users may then review the e-mail and visit the website 120, for example via an internet browser. For example, an identified user 140 may simply click on an HTML address that has been included in the introductory e-mail. Typically, the clicking activates a browser on the identified user's computer and directs the browser to the target website.

Once the identified users 140 have been contacted and attempt to visit the website 120, the identified users 140 are directed to a login screen 150. An exemplary login screen 150 is included in Appendix A. The login screen 150 requires users to enter information such as their name, company, position, address, phone number, e-mail address, and contact information, for example. Once the user completes the login screen 150, the user submits their information for processing. Preferably, the user information is submitted for processing by clicking on a button on the login screen 150.

The information from the login screen 150 is then directed to the profile database 160 where it is stored. The profile database 160 thus includes records and contact information for each user attempting to visit the web site 170.

Once the user 140 has completed the login screen 160 and the user's information has been entered into the profile database 160, a login password is e-mailed to the e-mail addressed specified by the user in their profile. The login password permits access to the web site 120.

The user 140 then begins to access the web site 120. As the user accesses the web site 120, the user's actions with regard to the web site are tracked and compiled to form the web use statistics database 170. Statistics tracked by the web use statistics database 170 may include average user session length, most requested pages, top entry pages, most downloaded files, most active organizations, and top referring sites and URLs (Universal Resource Locator), for example. The web use statistics may be correlated in a variety of fashions including by company or organization. Additionally, the web use statistics database 170 may include a correlation between an individual login or IP (Internet Protocol) address and the activity of that user on the web site 120.

When a targeted response is desired, the targeted response generator 180 accesses the profile database 160 and the web use statistics database 170. The targeted response generator 180 then analyzes the web use statistics to select from a variety of responses. For example, the targeted response generator 180 may determine from the web use statistics that a certain organization requested a page of the web site 120 dealing with intellectual property more times that the organization requested a page of the web site 120 dealing with capital structure. The targeted response generator 180 may interpret the relative number of page accesses to indicate that the target organization is more interested in intellectual property than capital structure. The targeted response generator 180 then initiates a targeted response based on the identified interests of the accessing organization. The targeted response may take the form of a specialized e-mail or a directed personal contact, for example. E-mail or other contact information for the targeted response is determined from the user information in the profile database 160. Additionally, the client corporation 110 may indicate other factors to include in the targeted response. Several different correlations between web site 120 usage and user interest may be developed, such as correlating average session length with page accesses for downloaded files, or correlating most requested pages with session length, for example. An exemplary “Web Statistic Summary Reports” for Jun. 24, 25, 26, and 28, 1999 are included in Appendix B. The Web Statistic Summary Reports illustrate typical profiles of viewers who accessed the client's web site.

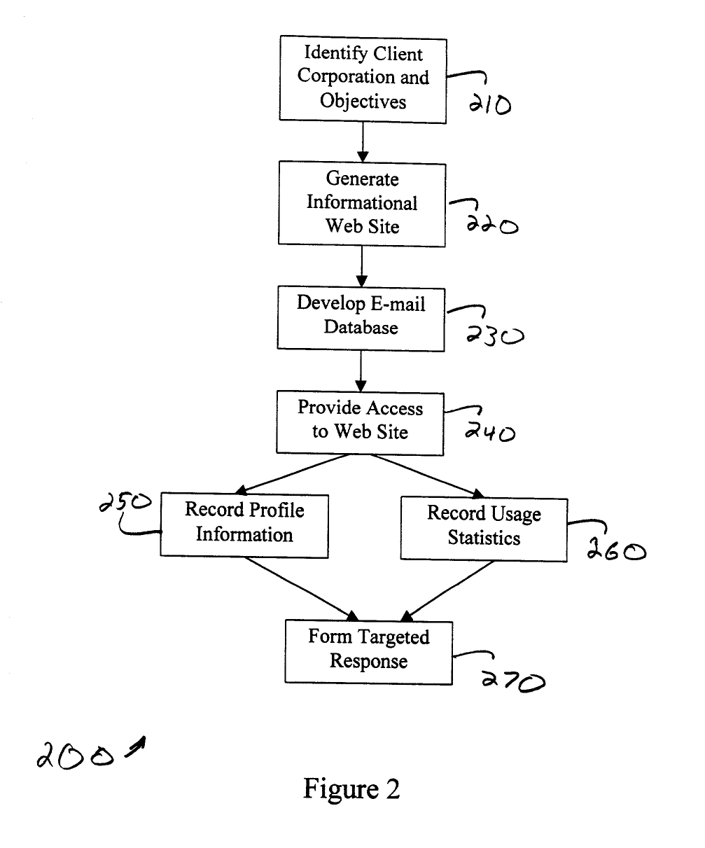

FIG. 2 illustrates a flowchart 200 of a preferred embodiment of the present invention. First, at step 210, the client corporation is identified, as well as the specific objectives and services requested by the corporation, for example, investment banking services. Next, at step 220, an internet-accessible compiliation such as an information web site is generated relating to the client company and its desired service. Then, at step 230, an e-mail database of potential interested contacts is constructed. As mentioned above the e-mail database may include organizations in a field similar to the client company, as well as presidents and research executives of such organizations, for example. Next, at step 240, access to the web site is provided. Access may be provided by e-mailing the HTML address of the website to the potential users, for example. Once the users attempt to access the website, they are met with a login screen which the user fills out with the user's contact information. The contact information is recorded in the profile database as described above, and the user is issued a password. Once the user uses their password and accesses the website, the activities of the user are tracked and recorded at step 260. At step 270, the usage statistics for the web site are analyzed and a targeted response is formed.

The preferred embodiment of the present invention may create profiles for companies, individuals, or other organizations such as educational institutions, for example, who access the client web site. The preferred embodiment of the present invention thus creates an “electronic book” with respect to profilees who have visited the web site. The preferred embodiment of the present invention assists in investment banking efforts by directing information to users that is most relevant to their concerns. Additionally, the electronic books of a competitor of the client corporation may be analyzed to determine the competitor's relative interests and thus assist in marketing or negotiation efforts.

While particular elements, embodiments and applications of the present invention have been shown and described, it is understood that the invention is not limited thereto since modifications may be made by those skilled in the art, particularly in light of the foregoing teaching. It is therefore contemplated by the appended claims to cover such modifications and incorporate those features which come within the spirit and scope of the invention.

1. A system for generating a targeted response including
an internet-accessible compilation of information regarding a client corporation and a specific investment banking objective of said client corporation;
an e-mail database including e-mail addresses of potential interested contacts;
a login for said compilation for gathering user's contact information and providing a password to users;
a profile database for storing said user's contact information;
a use statistics database for storing web usage statistics related to said internet-accessible compilation; and
a targeted response generator analyzing said usage statistics to determine a targeted response from a variety of target responses based on a determination of user interest.

2. The system of claim 1 wherein said internet-accessible compilation is a web page.

3. The system of claim 1 wherein said internet-accessible compilation is a bulletin board system.

4. The system of claim 1 wherein said user contact information includes postal mail information.

5. The system of claim 1 wherein said user contact information includes professional contact information.

6. The system of claim 2 wherein said usage statistics include at least one of session length, most requested pages, top entry pages, most downloaded files, most active organizations, and top referring sites.

7. The system of claim 1 wherein said targeted response includes at least one of an individualized e-mail, a phone contact or a postal letter.

8. The system of claim 1 wherein said e-mail database additionally alerts the potentially interested contacts by using a e-mail alert.

9. The system of claim 1 wherein said e-mail alert includes the URL of the profile database.

10. A method for generating a targeted response comprising the steps of:
identifying a client corporation having specific investment banking objectives;
generating an internet-accessible compilation of information relating to said client corporation and said specific investment banking objectives;
developing an e-mail database of potential interested contacts;
providing access to said internet-accessible compilation to said interested contacts;
recording profile information regarding visitors to said internet-accessible compilation;
recording use statistics regarding visitors to said internet-accessible compilation;
analyzing said profile information and said use statistics to form a targeted response to said visitors.

11. The method of claim 10 wherein said generating step includes generating an internet-accessible compilation as a web page.

12. The method of claim 10 wherein said generating step includes generating an internet-accessible compilation as a bulletin board system.

13. The method of claim 10 wherein said recording step includes recording postal mail information.

14. The method of claim 10 wherein said recording step includes recording professional contact information.

15. The method of claim 11 wherein said recording step includes recording use statistics including at least one of session length, most requested pages, top entry pages, most downloaded files, most active organizations, and top referring sites.

16. The method of claim 10 wherein said analyzing step includes forming a targeted response including at least one of an individualized e-mail, a phone contact or a postal letter.

17. The method of claim 10 further including the step of alerting the members of the e-mail database of potentially interested contacts by using a e-mail alert.

18. The method of claim 17 wherein said alerting step includes an e-mail alert including the URL of the profile database.
